(19) United States
(12) Patent Application Publication
(10) Pub. No.: US 2012/0269628 A1
(43) Pub. Date: Oct. 25, 2012

(54) Device of Floating Wind Turbine Capable of Counterbalancing Torques Therein

(76) Inventor: KUO-SHEN LIU, Taipei (TW)

(21) Appl. No.: 13/541,671

(22) Filed: Jul. 4, 2012

Related U.S. Application Data
(63) Continuation-in-part of application No. 13/081,460, filed on Apr. 6, 2011.

(51) Int. Cl. F03D 11/04; F03D 1/00

(52) U.S. Cl. 416/85

(57) ABSTRACT

A device of floating wind turbine comprises a floating foundation, wind turbines provided on the floating foundation, and a seabed anchor attached to the floating foundation, wherein the floating foundation is symmetrically provided with two wind turbines; the floating foundation and the two wind turbines are attached to the seabed anchor by tethers, whereby when the wind turbines are driven to generate electrical power, they respectively exert an upward force and a downward force at a center portion of the floating foundation between the two wind turbines; both turbines have an approximately equal speed and output power; whereby the upward force can be counterbalanced by the downward force, so that the wind turbines and the floating foundation can be maintained at a balanced condition.

### CROSS-REFERENCE TO RELATED APPLICATION

This application is a continuation-in-part of the co-pending patent application Ser. No. 13/081,460, owned by the same applicant.

### TECHNICAL FIELD OF THE INVENTION

The present invention relates to a device of floating wind turbine capable of counterbalancing torques therein and, more particularly, to a device of floating wind generator capable of counterbalancing torques therein, based on two wind turbines being symmetrically provided on a floating foundation, whereby when the two wind turbines are driven to generate electrical power, they respectively exert an upward force and a downward force at a central portion of the floating foundation between the two wind turbines, and due to both turbines having an approximately equal speed and output power, the upward force can be counterbalanced by the downward force and thus the wind turbines and the floating foundation can be maintained at a balanced condition.

### DESCRIPTION OF THE PRIOR ART

Since the wind power energy is the cheapest renewable energy for the moment of facing the imminent depletion of fossil-fuel energy, every country strived to develop the wind power technology these years. Due to the high cost of land and the fact that the wind is stronger and steadier on the sea, wind turbines are gradually installed in offshore area. However, if the water depth is more than 35 m, it will be more difficult to install a wind turbine. Thus, most of wind turbines are installed in nearshore area for the time being. The coverage and the strength of wind flow in nearshore area are of course less than those of an offshore area. Suppose an offshore wind turbine is desired to be installed in areas having water depths more than 35 m, the most simple way of installation is to provide a floating foundation for a wind turbine, as shown in FIG. 1, wherein the wind turbine 10 is mounted on the floating foundation 11, a ballast 12 is employed to keep balance between the front and the rear of the foundation, the floating foundation 11 is attached to an anchor 15 fixed on the seabed 14 by tethers or ropes 13, and further, the floating foundation 11 is provided with a vane 16 in stead of a yawing device to enable the floating foundation 11 to drift on the sea along the wind direction 17, so that the blades 19 of the wind turbine 10 can be kept in line with the wind direction. This method appears to be simple and economical. It is believed that lots of people want to do so. However, there is a problem making it infeasible. As shown in FIG. 2, when the blades 19 are rotated to generate power, the wind turbine 10 will have an electromagnetic force to snap the rotating shaft, which in turn converts the rotary kinetic energy to the electrical power. As a result, the torque of the blades 19 will act on the stator of the wind turbine 10, the tower and the floating foundation 11 (these three structures are fixedly joined together), thereby to cause the floating foundation 11 tilted or even tumbled, as shown in FIG. 2. So far, the problem is not solved. A number of patents such as U.S. Pat. Nos. 7,612,462, 7,156,586, 7,819,073, D0567176 cannot solve the problem.

In view of the foregoing, according to the long-term experiences of wind turbines and after continuous efforts on the research and experiment, the applicant has contrived a way to solve the above problem, by which torques exerted by the wind turbines can be counterbalanced, so that the wind turbines and the floating foundation can be maintained at a balanced condition.

### SUMMARY OF THE INVENTION

The primary object is to provide a device of floating wind turbine capable of counterbalancing torques therein, wherein two horizontal-axis wind turbines are symmetrically provided on a floating foundation. Due to both turbines having an approximately equal speed and output power, the torques exerted by the two wind turbines can be counterbalanced and thus the wind turbines and the floating foundation can maintain a balance.

The aforementioned device comprises a floating foundation, wind turbines provided on the floating foundation, and a seabed anchor attached to the floating foundation, wherein the floating foundation is symmetrically provided with two wind turbines; the floating foundation and the wind turbines are secured to a seabed anchor by tethers. When the wind turbines are driven to generate electrical power, the wind turbines respectively exert an upward force and a downward force at a central portion of the floating foundation between the two wind turbines. Due to both turbines having an approximately equal speed and output power, as long as the floating foundation is robust enough to bear the forces exerted by the wind turbines, the upward force can be counterbalanced by the downward force. Therefore, the wind turbines and the floating foundation can be maintained at a balanced condition.

In the aforementioned device, the two wind turbines each can be a horizontal-axis or vertical-axis wind turbine. Furthermore, the two wind turbines each can be an upwind design (i.e., the turbine blades placed in front of the nacelle) or a downwind design (i.e., the turbine blades placed at rear of the nacelle). Alternatively, one of the two wind turbines is an upwind design while the other of the two wind turbines is a downwind design.

### BRIEF DESCRIPTION OF THE DRAWINGS

FIG. 1 is a 3-dimensional view showing a construction of a floating wind turbine of prior art.

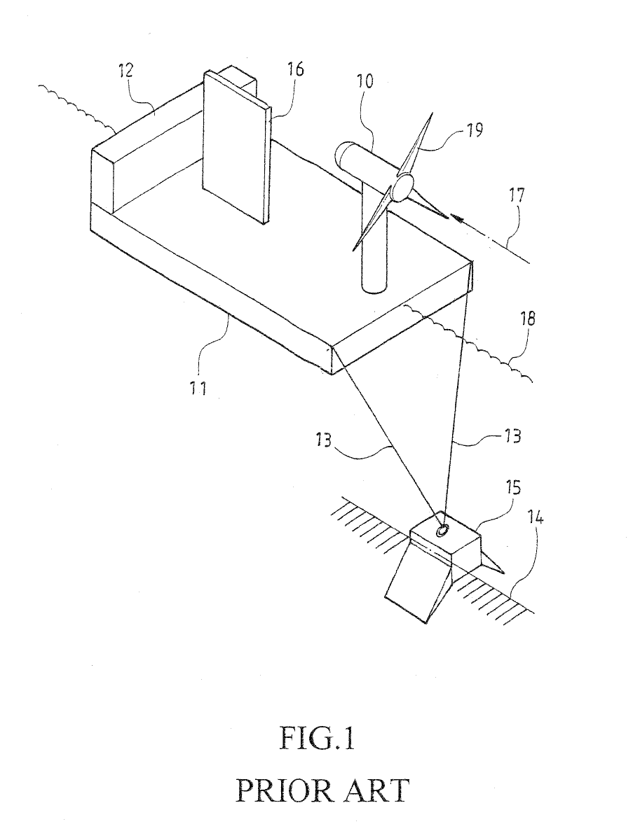

FIG. 2 is a schematic view illustrating a tilted condition of a floating wind turbine of prior art.

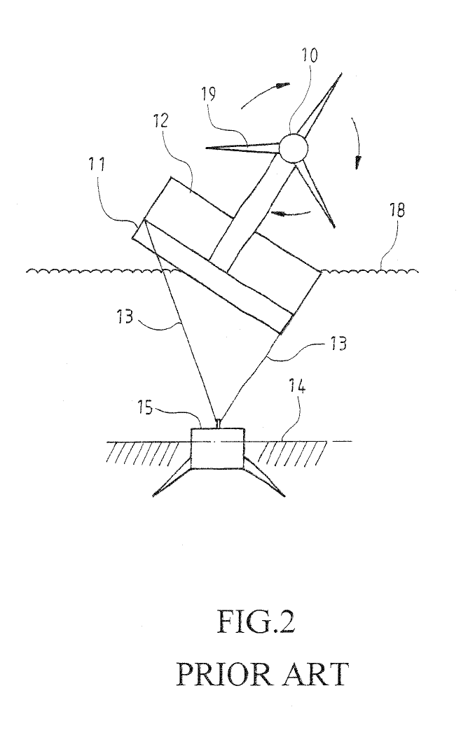

FIG. 3 is a 3-dimensional view showing a construction of one embodiment of the present invention.

FIG. 4 is a front view of the embodiment of the present invention shown in FIG. 3.

FIG. 5 is a front view showing a construction of another embodiment of the present invention.

### DETAILED DESCRIPTION OF THE PREFERRED EMBODIMENTS

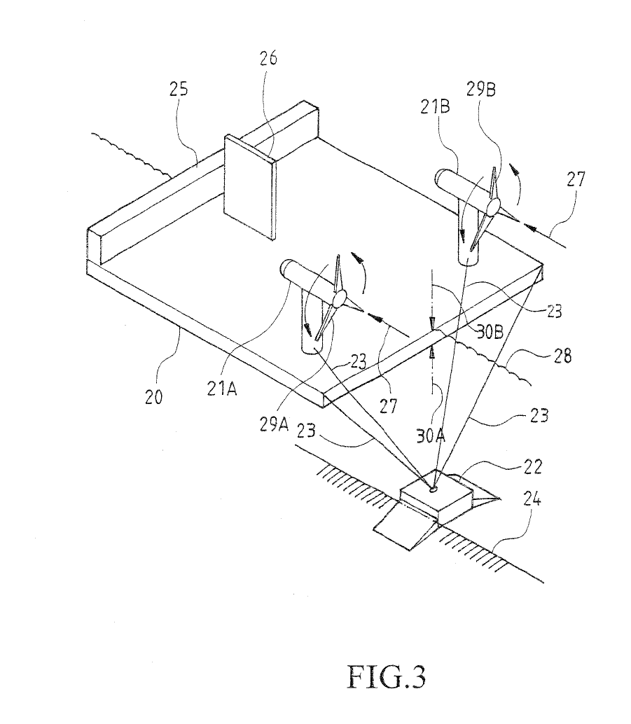

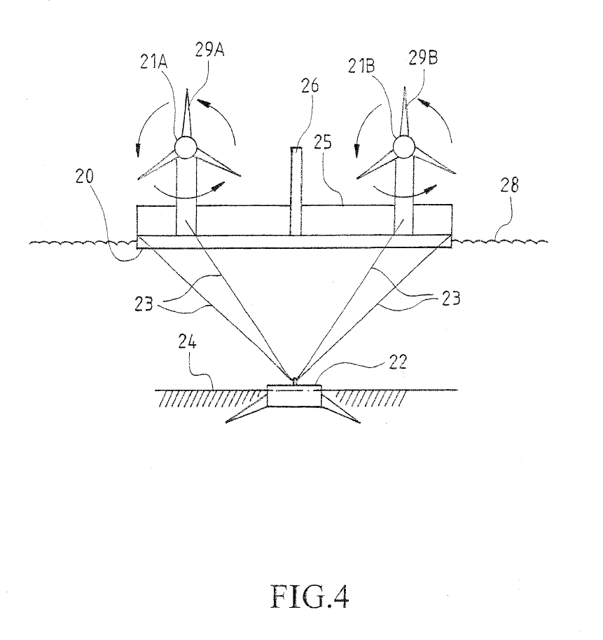

FIGS. 3 and 4 respectively show a construction view and a front view of one embodiment of the present invention. As shown, the present invention comprises a floating foundation 20, two wind turbines 21A, 21B symmetrically provided on the floating foundation 20, and a seabed anchor 22 attached to the floating foundation 20. In this embodiment, the two wind turbines 21A, 21B each can be a horizontal-axis or vertical-axis wind turbine, and furthermore, the two wind turbines 21A, 21B each can be an upwind design or a downwind design, or one of the two wind turbines is an upwind design while the other of the two wind turbines is a downwind design. The floating foundation 20 and the wind turbines 21A, 21B are attached to the seabed anchor 22 by tethers 23, in which the seabed anchor 22 is fixed on the seabed 24. The floating foundation 20 is further provided with a ballast 25 for keeping a balance between the front and the rear of the floating foundation 20, and is further provided with a vane 26 instead of a yawing device to enable the floating foundation 20 to drift on the sea 28 along the wind direction 27, so that the blades 29A of the wind turbine 21A and the blades 29B of the wind turbine 21B can be aligned with the wind direction 27.

With a combination of the aforementioned components, as shown in FIG. 3, when the two wind turbines are driven to generate electrical power, the wind turbine 21A exert an upward force 30A at a central portion of the floating foundation 20 between the two wind turbines, while the wind turbine 21B exert a downward force 30B at the central portion of the floating foundation between the two wind turbines. Since both turbines have an approximately equal speed and output power, as long as the floating foundation 20 is robust enough to bear these forces, the upward force 30A can be counterbalanced by the downward force 30B, so that the wind turbines 21A, 21B and the floating foundation 20 can be maintained at a balanced condition between the left and the right of the floating foundation.

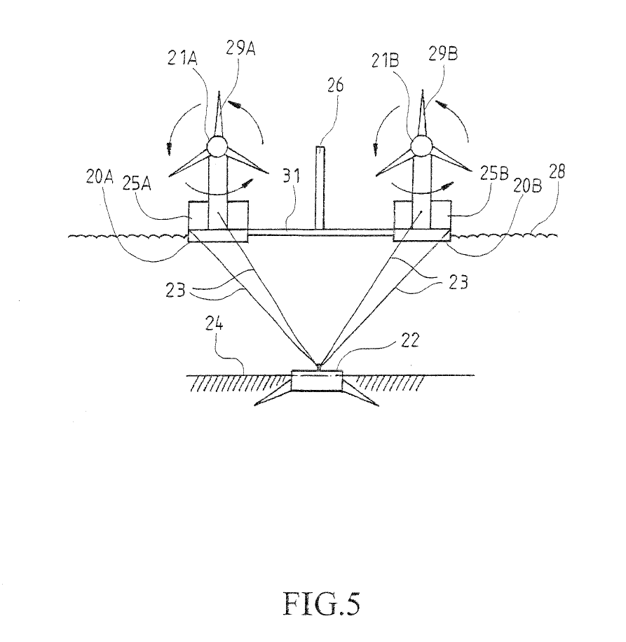

The floating foundation 20 may be designed to have any shapes or constructions. As shown in FIG. 5, another embodiment of the present invention is disclosed, wherein the floating foundation 20 is separated into two floating units 20A, 20B, between which one or more connecting beams 31 are connected so that the two floating units 20A, 20B can act in an integral manner. Furthermore, ballast 25A, 25B are respectively provided at the rears of the floating unit 20A, 20B, each ballast performing in a similar way to the ballast of the previous embodiment; a vane 26 is provided on the connecting beams 31, performing in a similar way to the vane of the previous embodiment. As long as the connecting beams 31 are robust enough to bear the forces exerted by the wind turbines 21A, 21B, the upward force exerted by one of the wind turbines can be counterbalanced by the downward force exerted by the other of the wind turbines.

In light of the foregoing, the present invention provides two wind turbines symmetrically provided on a floating foundation, wherein when the wind turbines are driven to generate electrical power, the wind turbines respectively exert an upward force and a downward force at a central portion of the floating foundation between the two wind turbines. Due to the two wind turbines having an approximately equal speed and output power, the upward force exerted by one of the wind turbines can be counterbalanced by the other of the wind turbines, so that the wind turbines and the floating foundation can be maintained at a balanced condition. Thus, the present invention is a useful design.

Although the present invention has been described with a certain degree of particularity, it is understood that the present disclosure is made by way of a preferred embodiment only, rather than a limitation of the scope of the invention. Any modifications and changes of parts may be resorted to without departing from the essence and the spirit of the invention.

I claim:

1. A device of floating wind turbine capable of counterbalancing torques therein, comprising a floating foundation, two wind turbines provided on said floating foundation, and a seabed anchor attached to said floating station and said wind turbine by tethers so that said floating foundation can drift on the sea along wind direction to have blades of said wind turbine aligned with wind direction, the device characterized in that:
said floating foundation are symmetrically provided with two wind turbines, wherein the two wind turbines has an approximately equal speed and output power; the two wind turbines respectively exert an upward force and a downward force at a central portion of said floating foundation between the two wind turbines, whereby the upward force can be counterbalanced by the downward force, so that said wind turbines and said floating foundation can be maintained at a balanced condition.

2. The device as claimed in claim 1, wherein the two wind turbines are each a horizontal-axis or vertical-axis wind turbine.

3. The device as claimed in claim 1, wherein the two wind turbines are each an upwind design or a downwind design, or one of the two wind turbines is an upwind design while the other of the two wind turbines is a downwind design.
